(19) United States
(12) Patent Application Publication
(10) Pub. No.: US 2024/0160963 A1
(43) Pub. Date: May 16, 2024

(54) INTELLIGENT BMC-BASED ON-DEVICE AI INTERWORKING METHOD

(71) Applicant: Korea Electronics Technology Institute, Seongnam-si (KR)

(72) Inventors: Jae Hoon AN, Incheon (KR); Young Hwan KIM, Yongin-si (KR); Han Gyeol KIM, Seongnam-si (KR)

(73) Assignee: Korea Electronics Technology Institute, Seongnam-si (KR)

(21) Appl. No.: 18/387,230

(22) Filed: Nov. 6, 2023

(30) Foreign Application Priority Data
Nov. 11, 2022 (KR) 10-2022-0150068

(51) Int. Cl. G06N 5/04

(52) U.S. Cl. CPC G06N 5/04

(57) ABSTRACT

There is provided an intelligent BMC for predicting a fault by interworking on-device AI. A fault prediction method of a BMC according to an embodiment includes: collecting monitoring information regarding computing modules installed on a main board; calculating a FOFL from the collected monitoring data; and constructing an AI model related to the calculated FOFL and predicting a FOFL from the monitoring data. Accordingly, a fault occurring in various patterns may be predicted based on monitoring data by interworking with on-device AI.

### CROSS-REFERENCE TO RELATED APPLICATION(S) AND CLAIM OF PRIORITY

This application is based on and claims priority under 35 U.S.C. § 119 to Korean Patent Application No. 10-2022-0150068, filed on Nov. 11, 2022, in the Korean Intellectual Property Office, the disclosure of which is herein incorporated by reference in its entirety.

### BACKGROUND

### Field

The disclosure relates to a baseboard management controller (BMC), and more particularly, to an intelligent BMC which predicts a fault by interworking with on-device artificial intelligence (AI).

### Description of Related Art

A BMC is a controller that is mounted in a server or a normal computer to provide an interface for managing a system between system management software and a hardware platform, and operates on an intelligent platform management interface (IPMI), intelligent platform management bus (IPMB)-based software architect through the interface.

Recently, the BMC may be used for managing not only a server, a storage, network equipment but also a data center infrastructure.

It may be considered that the BMC is used as a means for predicting a system fault since the BMC is a controller appropriate for system management, but there is a limitation to using the BMC since the BMC is poor in terms of advanced computing power.

### SUMMARY

The disclosure has been developed in order to solve the above-described problems, and an object of the disclosure is to provide an intelligent BMC which predicts a fault by interworking with on-device AI.

According to an embodiment of the disclosure to achieve the above-described object, a fault prediction method may include: collecting monitoring information regarding computing modules installed on a main board; calculating a FOFL from the collected monitoring data; and constructing an AI model related to the calculated FOFL and predicting a FOFL from the monitoring data.

Collecting and calculating may be periodically performed.

Predicting may be performed only when a FOFL is a defined level.

The FOFL may be set based on a policy set by a user.

According the disclosure, the fault monitoring method may further include storing the predicted FOFL in a DB as log data.

According the disclosure, the fault monitoring method may further include controlling the computing modules of the main board according to the predicted FOFL.

The AI model may be trained by an external platform.

The AI model may be driven in a SSP which is distinguished from a PSP of a BMC.

According the disclosure, the fault monitoring method may further include notifying a user of the predicted FOFL.

According to another aspect of the disclosure, an intelligent BMC may include: a monitoring engine configured to collect monitoring information regarding computing modules installed on a main board; a feedback engine configured to calculate a FOFL from the collected monitoring data; and a prediction module configured to construct an AI model related to the calculated FOFL and to predict a FOFL from the monitoring data.

According to still another aspect of the disclosure, a fault prediction method may include: calculating a FOFL from monitoring data regarding computing modules installed on a main board; providing AI model data for constructing an AI model related to the calculated FOFL; and constructing an AI model from the AI model data and predicting a FOFL from the monitoring data.

According to yet another aspect of the disclosure, a fault prediction system may include: a BMC configured to calculate a FOFL from monitoring data regarding computing modules installed on a main board, and to construct an AI model related to the calculated FOFL and to predict a FOFL from the monitoring data, and an AI model platform configured to provide AI model data to the BMC.

According to embodiments of the disclosure as described above, an intelligent BMC may predict a fault occurring in various patterns based on monitoring data by interworking with on-device AI.

According to embodiments of the disclosure, since an AI model to be used for predicting a fault is selected based on a result of predicting a fault preliminarily based on monitoring data, accuracy of AI-based fault prediction can be enhanced.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an overall firmware structure of an intelligent BMC;

FIG. 2 is a view illustrating a configuration of an intelligent BMC according to an embodiment of the disclosure; and

FIG. 3 is a sequence diagram provided to explain a fault prediction and feedback method according to another embodiment of the disclosure.

### DETAILED DESCRIPTION

Hereinafter, the disclosure will be described in more detail with reference to the accompanying drawings.

Embodiments of the disclosure propose an intelligent BMC which predicts a fault by interworking with on-device AI and provides feedback.

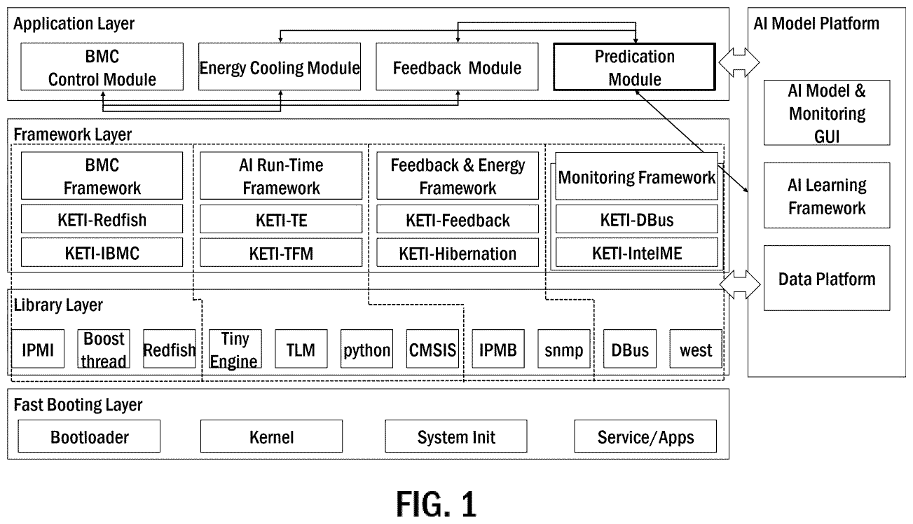

FIG. 1 is a view illustrating an overall firmware structure of an intelligent BMC. An on-device AI function may be performed through a tiny engine that is a trained AI model transmitted through an external AI model platform and operates in a prediction module. The firmware of the intelligent BMC performing such a function may include a four-layer structure (a fast booting layer, a library layer, a framework layer, an application layer).

In the application layer, a communication flow of respective modules may be seen. A module that reduces power consumption through energy cooling and a module that feeds back a fault level may be operated by a BMC control module. An on-device AI function of each module may operate by receiving data through a prediction module.

Inter-module communication and sensor data collection in the intelligent BMC may be performed based on a system DBus, and a computing module that is managed by the BMC may be monitored and controlled through a protocol such as an IPMI, an IPMB.

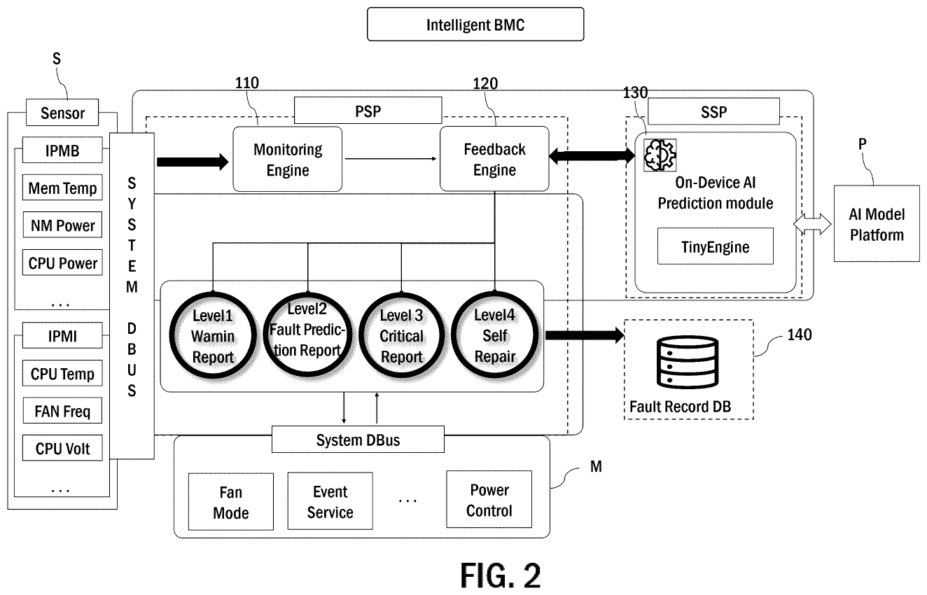

FIG. 2 is a view illustrating a configuration of an intelligent BMC according to an embodiment of the disclosure. The intelligent BMC may include a monitoring engine 110, a feedback engine 120, an on-device AI prediction module 130, and a fault record DB 140 as shown in FIG. 2.

The monitoring engine 110 may collect monitoring information regarding computing modules installed on a main board through sensors S. Communication between the monitoring engine 110 and the sensors S may be performed through a protocol such as an IPMI, an IPMB, based on the system DBus.

The feedback engine 120 may calculate a fault outbreak feedback level (FOFL) from the monitoring data collected by the monitoring engine 110. It is imagined that the FOFL in FIG. 2 is divided into four levels in total, but this is merely an example. The FOFL may be divided into a number of levels according to a policy set by a user.

The on-device AI prediction module 130 may predict a FOFL from the monitoring data by using an AI model. The AI model is an AI model that is trained to predict a FOFL by analyzing monitoring data.

The AI model may be trained by an AI model platform P, and the on-device AI prediction module 130 may receive trained AI model data from the AI model platform P, and may construct an AI model and predict a FOFL.

There may be four types of AI models, and an AI model to be used may be determined according to a FOFL which is calculated by the feedback engine 120. Specifically, AI model #1 may be used when the FOFL calculated by the feedback engine 120 is level 1, AI model #2 may be used when the FOFL is level 2, AI model #3 may be used when the FOFL is level 3, and AI model #4 may be used when the FOFL is level 4.

Accordingly, the on-device AI prediction module 130 may request corresponding AI model data from the AI model platform P, based on the FOFL calculated by the feedback engine 120, and may receive the AI model data.

The on-device AI prediction module 130 may be implemented in a secondary service processor (SSP) which is distinguished from a primary service processor (PSP) of the intelligent BMC, and thereby may operate the AI model with a tiny engine.

The fault record DB 140 is a DB in which a FOFL predicted by the on-device AI prediction module 130 is stored as log data.

Computing modules M of the main board may be controlled by the feedback engine 120 according to a FOFL predicted by the AI prediction module 130. Communication between the feedback engine 120 and the modules M may be performed through a protocol such as an IPMI, an IPMB, based on the system DBus.

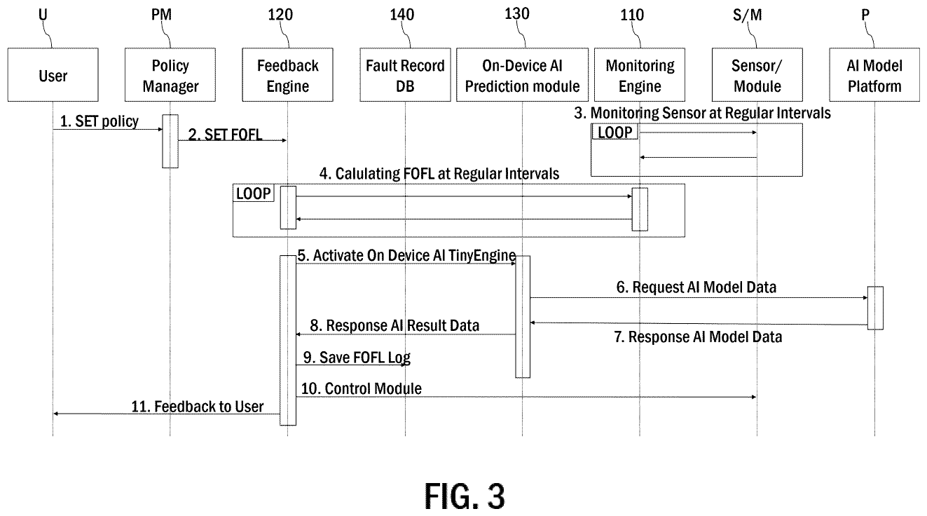

Hereinafter, an operating process of the intelligent BMC shown in FIG. 2 will be described in detail with reference to FIG. 3. FIG. 3 is a sequence diagram provided to explain a fault prediction and feedback method according to another embodiment.

As shown in FIG. 3, when a user U sets a fault feedback policy (1), a policy manager (PM) may set a FOFL in the feedback engine 120 according to the policy (2). The fault feedback policy is a policy that defines fault levels of FOFL and detailed contents according to fault levels.

The monitoring engine 110 may periodically collect monitoring information regarding computing modules M installed on a main board through a sensor S (3).

The feedback engine 120 may periodically calculate a FOFL based on monitoring data collected by the monitoring engine 110 (4). The feedback engine 120 may request the on-device AI prediction module 130 to predict a fault while transmitting the calculated FOFL to the on-device AI prediction module 130 along with the monitoring data (5).

Then, the on-device AI prediction module 130 may request AI model data corresponding to the calculated FOFL from the AI model platform P (6), and the AI model platform P provides corresponding AI model data to the on-device AI prediction module 130 (7).

Thereafter, the on-device AI prediction module 130 may construct an AI model from the AI model data provided from the AI model platform P, and may predict a FOFL from the monitoring data and may return a result of predicting to the feedback engine 120 (8).

The feedback engine 120 may store the FOFL predicted by the on-device AI prediction module 130 in the fault record DB 140 as log data (9), and may control the computing modules M of the mainboard according to the predicted FOFL (10).

Finally, the feedback engine 120 may notify the user U of the FOFL predicted by the on-device AI prediction module 130.

Up to now, a method of configuring an intelligent BMC to predict a fault by interworking with on-device AI, and predicting a fault occurring in various patterns based on monitoring data, and feeding back a result of predicting has been described in detail.

In the above-described embodiments, an AI model to be used for predicting a fault may be selected based on a result of predicting a fault preliminarily based on monitoring data, so that accuracy of AI-based fault prediction can be enhanced.

In the above-described embodiments, it is conceived that FOFL prediction by the AI model is periodically performed, but a change may be made thereto. For example, FOFL prediction by the AI model may be performed only when a FOFL calculated by the feedback engine 120 is a defined level. Herein, the defined level may be limited to levels that are calculated when faults other than a slight fault or a severe fault occur.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A fault prediction method comprising:
collecting monitoring information regarding computing modules installed on a main board;
calculating a FOFL from the collected monitoring data; and
constructing an AI model related to the calculated FOFL and predicting a FOFL from the monitoring data.

2. The fault monitoring method of claim 1, wherein collecting and calculating are periodically performed.

3. The fault monitoring method of claim 2, wherein predicting is performed only when a FOFL is a defined level.

4. The fault monitoring method of claim 1, wherein the FOFL is set based on a policy set by a user.

5. The fault monitoring method of claim 1, further comprising storing the predicted FOFL in a DB as log data.

6. The fault monitoring method of claim 1, further comprising controlling the computing modules of the main board according to the predicted FOFL.

7. The fault monitoring method of claim 1, wherein the AI model is trained by an external platform.

8. The fault monitoring method of claim 1, wherein the AI model is driven in a SSP which is distinguished from a PSP of a BMC.

9. The fault monitoring method of claim 1, further comprising notifying a user of the predicted FOFL.

10. An intelligent BMC comprising:
a monitoring engine configured to collect monitoring information regarding computing modules installed on a main board;
a feedback engine configured to calculate a FOFL from the collected monitoring data; and
a prediction module configured to construct an AI model related to the calculated FOFL and to predict a FOFL from the monitoring data.

11. A fault prediction method comprising:
calculating a FOFL from monitoring data regarding computing modules installed on a main board;
providing AI model data for constructing an AI model related to the calculated FOFL; and
constructing an AI model from the AI model data and predicting a FOFL from the monitoring data.
